(19) United States
(12) Patent Application Publication
(10) Pub. No.: US 2017/0021283 A1
(43) Pub. Date: Jan. 26, 2017

(54) Doll System

(71) Applicant: Elaine Jones, Peekskill, NY (US)

(72) Inventor: Elaine Jones, Peekskill, NY (US)

(21) Appl. No.: 15/051,211

(22) Filed: Feb. 23, 2016

Related U.S. Application Data
(60) Provisional application No. 62/119,493, filed on Feb. 23, 2015.

(51) Int. Cl. A63H 3/28; A63H 3/00; G09B 25/00; A63H 3/36; A63H 3/44

(52) U.S. Cl. CPC A63H 3/28; A63H 3/36; A63H 3/44; G09B 25/00; A63H 3/003

(57) ABSTRACT

A doll system is provided and comprises a plurality of dolls. The form and likeness of each doll is based on a plurality of developmental stages of a specific female or male child. Each doll is constructed to directly correspond to images of actual models at different ages.

### CLAIM OF PRIORITY

This patent application claims priority under 35 USC 119 (e) (1) from U.S. Provisional Patent Application Ser. No. 62/119,493 filed Feb. 23, 2015, of common inventorship herewith entitled, “The World International Design Doll,” which is incorporated herein by reference as though the same were set forth in its entirety.

### FIELD OF THE INVENTION

The present invention pertains to the field of children's toys, and more specifically to the field of life like dolls used for educational and other purposes.

### BACKGROUND OF THE INVENTION

Perhaps one of the oldest toys known to human civilization is the doll. A favorite amongst children and adults alike, the process of making and collecting dolls dates as far back as approximately two thousand BC when children played with flat pieces of wood painted to represent a human being and adorned with hair made of strings of clay or wooden beads. Simple clay, rag, wood, or bone dolls in ancient civilizations were cherished possessions commonly buried with children. By approximately six hundred BC, the desire to make dolls more lifelike was an important goal of artisans. In fact, by this time in history, dolls were already being crafted with movable limbs and removable clothing. By renaissance times, dolls were made of everything from wood pulp, sawdust and glue to the fine bone china doll created specifically for the wealthy. In early colonial times, native Indian children played with artfully crafted dolls made of corn husks while English settlers made dolls from rags and castoffs, creating, lovable, soft creatures for their daughters and sons.

Today, dolls are more popular than ever before and the result is a booming doll industry. Favorite dolls of children include cuddly newborn baby dolls, dolls that eat, wet a diaper and close their eyes and even dolls that walk, crawl, and talk. High fashion dolls, such as Barbie and her legion of friends, are popular with little girls and provide a fun and imaginative way in which to play grown up. There are countless versions of male dolls on the market, geared specifically toward young boys. Another popular aspect of the doll industry includes collectable dolls. Although hand painted dolls crafted of fine porcelain have always been a favorite of collectors, action figures and celebrity dolls are highly desirable collectibles.

The prior art has put forth several designs for life like dolls. Among these are:

US Patent Application 2007/0128979 to Judith Shackelford, Adam Anderson and Jason Heller describes a high tech doll that produces human-like expressions, recognizes words, and is able to carry on a conversation with a living person. The doll addresses time based subjects such as the food to eat at various times of the day. The doll expresses attitudes, emulating a living child. A child player acquires an emotional bond to the doll whilst the doll appears to bond to the child. The doll exhibits facial expressions produced concurrently with spoken words or separately to provide body language, representing emotions, such as happiness, sadness, grief, surprise, delight, curiosity, and so on, reinforcing the emulation of a living child.

U.S. Pat. No. 6,497,605 to Cummings and Joanne Gerson describes an operator controlled bilingual or multilingual toy, such as a doll, with a programmable controllable voice synthesizer. When activated, the circuit of the toy synthesizes a first random phase selected from a bank of phrases. When activated a second time, the circuit of the toy reproduces that first phrase as a translated phrase in a second language. After a specified elapse of time or a continued reactivation within a specified period of time, this process is repeated by the choice of a second, third and so forth randomly accessed phases. Each of the phrases is followed by a translation of that phrase. If neither a manual switch nor a second motion switch is activated within a predetermined time, the toy automatically turns off.

U.S. Pat. No. 4,696,653 to James McKeefery describes a toy doll which responds with spoken words and sentences to the touching of selected portions of the doll by a user and also voice actuation by a user. Specific areas of the doll, such as eyes, ears and nose, are provided with touch switches. When one of the switches is activated, the doll responds with one of two randomly selected sentences related to that part which was touched. In addition, voice actuation is provided by a microphone located within the doll. When the user speaks to the doll, the microphone senses the speech. After the speech has stopped for a fixed period of time, usually one second, the doll responds with a randomly selected sentence. Audio responses are stored by means of ROM in circuitry within the doll. The vocabulary of the doll is changed or enlarged with additional ROMs. To conserve power, a gravity switch is provided to turn the doll on when the doll is placed in a sitting position or otherwise moved. If the doll is still or receives no touch or voice stimulation for a period of approximately three minutes, the power is turned off.

None of these prior art references describe the present invention.

### SUMMARY OF THE INVENTION

It is an object of the present invention to provide a line of collectible dolls with the form and likeness of the doll based on three developmental stages of a specific female or male child.

The present invention is a doll system comprising a plurality of dolls. The form and likeness of each doll is based on a plurality of developmental stages of a specific female or male child. Each doll is constructed to directly correspond to images of actual models at different ages.

In addition, the present invention is method for creating a doll system. The method comprises providing a plurality of dolls, forming the likeness of each doll based on a plurality of developmental stages of a specific female or male child, and constructing each doll to directly correspond to images of actual models at different ages.

The present invention further includes a doll system comprising a plurality of dolls. The form and likeness of each doll based on a three developmental stages of a specific female or male child with the developmental stages being a first developmental stage, a second developmental stage, and a third developmental stage. A sound producing system is mounted within each doll and an activation switch for selectively turns the sound producing system on and off. Each doll can talk and sing and is constructed to directly correspond to images of actual models at different ages.

### BRIEF DESCRIPTION OF THE DRAWINGS

FIG. 1 is a perspective view illustrating a doll of the doll system constructed in accordance with the present invention, with the doll being in a first life stage containing life-like hair.

FIG. 2 is a perspective view illustrating the doll of the doll system constructed in accordance with the present invention, with the doll being in a second life stage containing life-like hair.

FIG. 3 is a perspective view illustrating the doll of the doll system constructed in accordance with the present invention, with the doll being in a third life stage containing life-like hair and a detachable head and bust figure.

FIG. 4 is a perspective view illustrating the doll of the doll system constructed in accordance with the present invention, with removable hair.

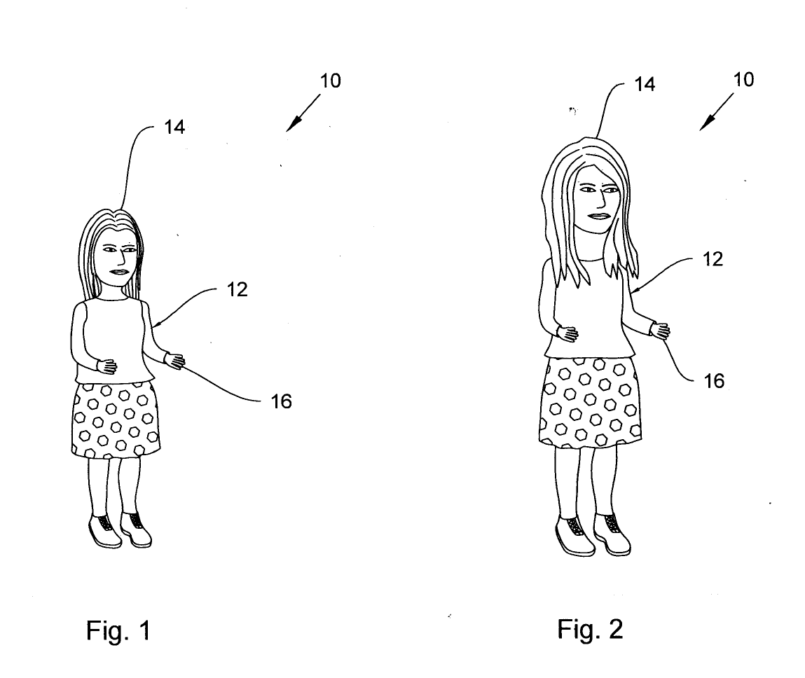

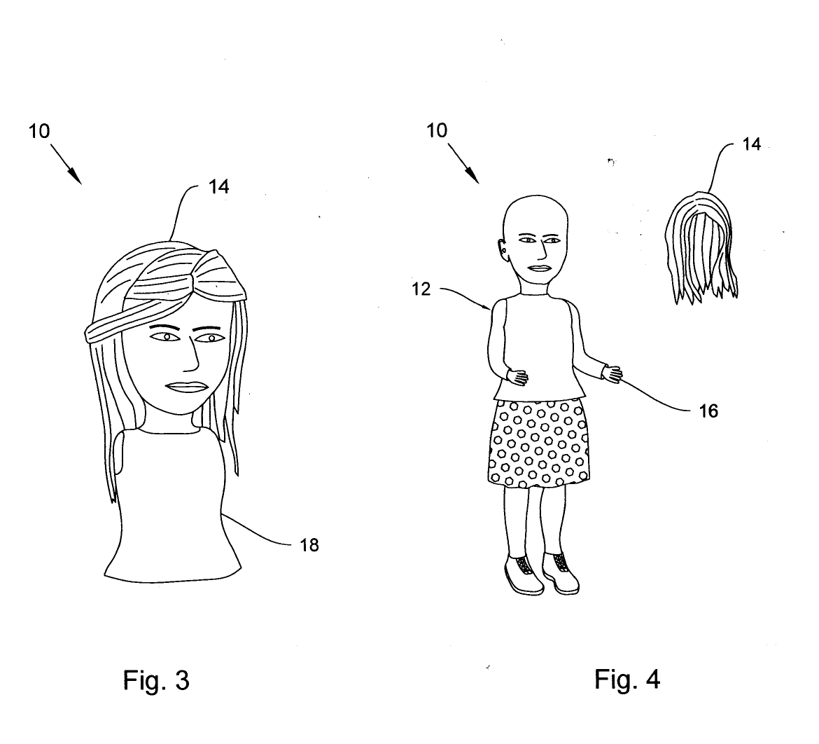

### DETAILED DESCRIPTION OF THE INVENTION

The present invention, hereinafter referred to as a Doll System, indicated generally at 10, is a line of collectible dolls 12 with the form and likeness of the doll 12 based on three developmental stages of a specific female or male child useful for educational and other purposes. A certificate of authenticity can be provided for each of the dolls 12 thereby making the dolls 12 more collectible and valuable for a user.

The Doll System 10 of the present invention provides a beautiful novel doll 12 that appeals to all ages, serving as a toy for children, a collectable for adults, and a training tool for new hairstylists. Each doll 12 is made to correspond to images of actual client's models at different ages. The doll 12 preferably represents three stages of a young child's life. The first stage is infancy to approximately two years old. The second stage is approximately three years old to approximately seven years old. The third stage is approximately eight years old to her preteen years. Each doll 12 comprises a child's friendly face, twinkling eyes, upturned nose, and smiling mouth. The hair 14 of the doll 12 is textured and life-like on all dolls 12, in curly and straight forms of different shades.

The Doll System 10 of the present invention comprises talking and singing dolls 12, containing an integrated sound player housed within the body of the doll 12 and activated by means of a simple switch mechanism incorporated into one of the hands 16 of the doll or elsewhere on the doll 12. A child needs only to squeeze the hand 16 or other designated area of the doll 12 and sounds are emitted through audio speakers incorporated in the audio player. The doll 12 of the Doll System 10 talks and sings in a variety of languages including English, Spanish, and French. English is preferably the primary language with other languages available. Verbal questions, conversation segments and positive reinforcement phrases are part of the preprogrammed vocabulary of the doll 12. The doll 12 also is preprogrammed with wiggle and shake movements that are activated when the doll 12 is singing. A computer chip or other type of memory device can be used to store the languages and movements of the doll 12.

The life-like hair 14 of the doll 12 of the Doll System 10 of the present invention can be repeatedly styled using standard heat styling tools. The face 12 of the doll is preferably heat resistant so that it unharmed during heat styling and is preferably resistant to shampoos, perms, or dyes. Adding to the life-like style of the doll 12, each doll 12 preferably has eyelashes that open and shut. In addition, each doll 12 includes an outfit with accessories such as earrings, a brush and comb, a hair dryer, rollers, rubber bands and hair accessories.

These lifelike and durable plastic dolls 12 of the Doll System 10 of the present invention are configured to represent the various stages of a young child's development. The doll 12 line of the Doll System 10 provides a delightful toy that entertains and educates children. An alternative option to ordinary dolls, the doll 12 talks and sings in different languages, exposing children to different cultures. Doll collectors enjoy selecting various offerings in the line, choosing dolls 12 to best compliment an existing collection or building a unique collection comprised entirely of the Doll System 10.

The Doll System 10 of the present invention provides a thoughtful gift and heirloom collectible to be passed down through generations. The preteen doll 12 has a detachable head and shoulders to enable creating a standalone bust FIG. 18 that functions as an instructional tool for cosmetology students learning to style hair or for seasoned cosmetologists trying new and creative looks. The doll 12 is enjoyed like any other doll providing a faithful play thing and loving friend, becoming a thoughtful keepsake over time. Collectors may display the doll 12 in a designated area of their home such as on a shelf or inside a curio cabinet. Carefully crafted of quality materials in a seeming likeness to a real child, the present invention will withstand many years of enjoyment.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A doll system comprising:
a plurality of dolls, the form and likeness of each doll based on a plurality of developmental stages of a specific female or male child;
wherein each doll is constructed to directly correspond to images of actual models at different ages.

2. The doll system of claim 1 and further comprising:
a first developmental stage;
a second developmental stage; and
a third developmental stage.

3. The doll system of claim 2 wherein the first developmental stage is infancy to two years old, the second developmental stage is three years old to seven years old, and the third developmental stage is eight years old to preteen years.

4. The doll system of claim 3 wherein the third developmental stage doll has a bust section removable from the remaining portion of the doll.

5. The doll system of claim 1 wherein each doll has hair, the hair being textured and life-like.

6. The doll system of claim 5 wherein the hair is removable.

7. The doll system of claim 1 and further comprising:
a sound producing system mounted within each doll;
wherein each doll can talk and sing.

8. The doll system of claim 7 and further comprising:
an activation switch for selectively turning the sound producing system on and off.

9. The doll system of claim 8 wherein the activation switch is positioned in a hand of each doll such that the sound producing system is activated by pressure applied to the activation switch.

10. The doll system of claim 7 and further comprising:
at least one speaker mounted within each doll.

11. The doll system of claim 7 wherein each doll talks and sings in a variety of languages including English, Spanish, and French.

12. The doll system of claim 11 wherein each doll communicates verbal questions, conversation segments, and positive reinforcement phrases.

13. The doll system of claim 7 wherein each doll includes wiggles and shake movements activated when each doll is singing.

14. The doll system of claim 1 and further comprising:
earrings, a brush and comb, a hair dryer, rollers, rubber bands, and hair accessories.

15. A method for creating a doll system, the method comprising:
providing a plurality of dolls;
forming the likeness of each doll based on a plurality of developmental stages of a specific female or male child; and
constructing each doll to directly correspond to images of actual models at different ages.

16. A doll system comprising:
a plurality of dolls, the form and likeness of each doll based on a three developmental stages of a specific female or male child, the developmental stages being a first developmental stage, a second developmental stage, and a third developmental stage;
a sound producing system mounted within each doll;
an activation switch for selectively turning the sound producing system on and off.
wherein each doll can talk and sing;
wherein each doll is constructed to directly correspond to images of actual models at different ages.

17. The doll system of claim 16 wherein the first developmental stage is infancy to two years old, the second developmental stage is three years old to seven years old, and the third developmental stage is eight years old to preteen years.

18. The doll system of claim 16 wherein the activation switch is positioned in a hand of each doll such that the sound producing system is activated by pressure applied to the activation switch.

19. The doll system of claim 16 and further comprising:
at least one speaker mounted within each doll.

20. The doll system of claim 16 wherein each doll includes wiggles and shake movements activated when each doll is singing.
